(19) United States
(12) Patent Application Publication
(10) Pub. No.: US 2026/0148572 A1
(43) Pub. Date: May 28, 2026

(54) Ordered Data Structure for Computer-Readable Representation of a Driving Surface Boundary and Training Procedure for AI-Based Environment Detection System

(71) Applicant: Robert Bosch GmbH, Stuttgart (DE)

(72) Inventors: Joel Janai, Leonberg (DE); Thomas Wenzel, Hamburg (DE); Bangyu Zhu, Stuttgart (DE); Nikolay Kadrileev, Stuttgart (DE); Yassin Kaddar, Stuttgart (DE)

(21) Appl. No.: 19/395,190

(22) Filed: Nov. 20, 2025

(30) Foreign Application Priority Data
Nov. 22, 2024 (DE) 10 2024 211 210.0

(51) Int. Cl. G06V 20/56; G06N 3/08; G06V 10/72; G06V 10/764; G06V 10/766; G06V 10/776; G06V 20/70

(52) U.S. Cl. CPC G06V 20/588; G06N 3/08; G06V 10/72; G06V 10/764; G06V 10/766; G06V 10/776; G06V 20/70

(57) ABSTRACT

An ordered data structure for the computer-readable representation of a physical linear driving surface boundary in the surroundings of a vehicle as a virtual linear driving surface boundary is disclosed. The data structure is stored in a memory or communicated via a data interface and is either a component of a training data set for training an environment recognition system. The training data set further includes environment detection data which is a sensory representation of a vehicle environment in which the at least one physical linear driving surface boundary is located; OR a component of an output data set of an environment detection system. The ordered data structure defines a line object with a list of support points. The line object is assigned a semantic line property that characterizes the entire line object as a virtual linear driving surface boundary. At least one of the support points is assigned a separate semantic point property.

This application claims priority under 35 U.S.C. § 119 to application no. DE 10 2024 211 210.0, filed on Nov. 22, 2024 in Germany, the disclosure of which is incorporated herein by reference in its entirety.

The present disclosure relates to an AI-based recognition technique for recognizing driving surface boundaries and their representation in an AI-based environment recognition system as ordered data structures.

### BACKGROUND

DE 10 2023 200 571 A1 describes a method for recognizing line structures in image data.

It is the task of the present disclosure to demonstrate an improved AI-based recognition technique.

The disclosure solves this task by that which is disclosed below.

### SUMMARY

A first aspect of the present disclosure relates to an ordered data structure for computer-readable representation of a physical linear driving surface boundary (Lim) in the environment of a vehicle as a virtual linear driving surface boundary (10) with the features according to the description set forth below. The description below also sets forth preferred embodiments of such a semantic point property. The ordered data structure can be a component of a training data set for training an environment recognition system. Alternatively or additionally, the ordered data structure may be a component of an output data set that is output by the environment detection system trained in accordance with the present disclosure.

In other words, one aspect of the present disclosure relates to a training data set for training an environment recognition system, wherein the training data set comprises at least one ordered data structure with the further features set forth below. Furthermore, one aspect of the present disclosure relates to an output data set that is output by the environment detection system, wherein the environment detection system is preferably trained using a training procedure according to the present disclosure and the output data set comprises at least one ordered data structure with the further features according to the description set forth below.

In the ordered data structure, a line object is defined with a list of support points, wherein at least one of the support points is assigned a separate semantic point property.

Examples of such semantic point properties in general formulation are:
Start and end position of differently labeled portions of a lane marking (start/end dash).
Switching between different types of driving surface boundaries or their segments, such as switching between dashed and solid lane markings (dash-solid, solid-dash)
A transition point at which lanes are split or merged (split/merge)
Switching between different types of driving surface boundaries, such as switching between raised and lowered curbs as driving surface boundaries
Interruptions in lane markings and/or driving surface boundaries (start/end interruption)
Occlusion of a driving surface boundary by (external) objects or the static scene (start/end occlusion).

By assigning at least one separate semantic point property to a support point of the line object representing a virtual linear driving surface boundary, significant improvements can be achieved for training a neural network, reducing false recognition and speeding up processing. The point properties allow a more complete assignment of features that are relevant for computer-aided detection. These assigned point properties can be used directly in learning methods to learn key points or segments. Alternatively or additionally, they can be used to support training in the calculation of at least one error function (loss).

The point properties can be assigned in any way. For example, they can be set or changed by manual or partially automated annotation in training data. The semantic point properties can also be used to define any information relevant to the environment detection system. A preferred embodiment provides, for example, that various point properties are used to determine that the respective support point has a certain line detection type, for example is “part of a lane marker” or “part of a gap between lane markers”. Alternatively or additionally, semantic point properties

can specify that the respective support point has a transition to a specific line detection type or from a specific line detection type, e.g. “Start lane marker” or “End lane marker”.

The assignment at the outline level of the support points enables fine-grained semantic marking, which is particularly finer than if only a complete line object or a line segment were annotated with a semantic line property or segment property. On the other hand, semantic point properties do not necessarily have to be assigned for all support points. Instead, (manual or checking) annotation can be carried out exclusively or predominantly for particularly important support points.

From a pair or group of support points that are assigned identical or matching semantic point properties, a semantic line property can also be derived for a complete line object or a line segment within a line object, and/or a semantic segment property can be captured for a segment section of a line object. The derived line property or segment property can be assigned automatically so that manual or semi-automatic assignment of a semantic line property / segment property can be dispensed with if necessary. This can save a considerable amount of time and money when preparing training data sets.

The virtual linear driving surface boundary can otherwise be defined in any way. Preferably, it has an end-to-end definition, wherein a first support point lies at a vanishing point and a second support point lies on an edge portion of the environment detection data. The end-to-end definition has proven to be particularly robust and advantageous for recognizing the boundaries of a vehicle's ego lane and any adjacent lanes.

A semantic point property, which is assigned to a support point of a line object in an output data set, can improve the further processing of the virtual linear driving surface boundary for recognizing lanes and special surfaces.

A preferred embodiment provides that a separate semantic point property is assigned to a plurality of support points, in particular all support points of a line object. The semantic point property can have a “default” value. On the other hand, two or more semantic point properties can be assigned to a support point. A training procedure for training an AI-based environment detection system according to the description set forth below provides an advantageous way of processing semantic point properties during training of a neural network.

A training data set is read in, which comprises environment detection data that is a sensory representation of a vehicle environment in which the at least one physical linear driving surface boundary is located. The environment detection data can be of any type and can include, for example, a camera image of the vehicle environment, a video image of the vehicle environment and/or a LiDAR data set of the vehicle environment. The training data set further comprises at least one ordered data structure according to the present disclosure.

Such a training data set makes the aforementioned fine-grained labeling of the environment detection data available in a particularly favorable way for processing in a training procedure. In particular, it is possible to use the semantic point properties individually and/or in pairs/groups when optimizing error functions of the neural network.

A first use provides that in the neural network a semantic point property to be determined by the neural network is defined as a point classification problem, and that the semantic point property assigned to a support point (in the training data set) is processed for the optimization of the classification error function (assigned to the point classification problem).

An alternative or additional use provides that in the neural network, a semantic line detection type to be determined by the neural network is defined as a line classification problem, and that the semantic point properties assigned to two support points in the training data set are processed for optimizing the classification error function (assigned to the line classification problem). In the context of the present disclosure, driving surfaces are to be understood as those areas of roads on which a vehicle, in particular a motor vehicle, can move. A driving surface is usually aligned horizontally or has a certain permissible inclination in relation to the horizontal. Driving surfaces include, in particular, paved road surfaces. Driving surfaces do not include grass areas, embankments or vertical surfaces, for example. In most applications, the driving surfaces have at least one lane with a designated direction of travel. This direction of travel is understood here as the longitudinal direction. Two or more lanes can also be provided.

However, there are also road surfaces on which no travel lanes are defined at least in sections. Alternatively or in addition to lanes, there may also be special areas. These can be divided into special areas approved for the vehicle's ego movement, such as parking areas, driveways or hard shoulders, and special areas not approved for the vehicle's ego movement, such as cycle paths and footpaths.

A driving surface is usually a component of a roadway. The roadway can be identical to a lane or a group of lanes. Alternatively, a roadway can include at least one additional special area. One or more lanes are often arranged in such a way that they run parallel to each other and have the same direction of travel or opposite directions of travel. Furthermore, several lanes can intersect, e.g. at junctions, or branch off or merge into one another or have one lane end, e.g. at junctions.

For various control mechanisms in a vehicle, it is essential that environment recognition is performed in which lanes are detected and made available as virtual objects in a form that can be processed by a computer. If necessary, the special areas can also be recognized.

An essential component or section of the environment recognition system concerns the recognition of physical driving surface boundaries and their computer-processable representation as virtual driving surface boundaries. In the real world, physical driving surface boundaries most commonly take the form of a physical road edge or lane marking.

A lane marking can consist of a single lane marker and can, for example, be a solid strip along a lane. Alternatively, a lane marking can consist of a group of lane markers, e.g. several spaced strips. In particular, the group of lane markers can be arranged along an (imaginary) line. A lane marker can also be a body delimited from the road surface, for example a Botts'Dot (round, non-reflective raised lane marker in the USA) or a reflector block or an elastic marking flag.

The present disclosure is specifically directed to providing an amount for recognizing linear driving surface boundaries present in the vehicle environment, which in particular extend along the direction of travel or define or can define the permissible direction of travel of a lane. These can also be physical lane edges and physical lane markings.

Virtual linear driving surface boundaries corresponding to these physical linear driving surface boundaries are defined as part of the environment recognition system. These virtual linear driving surface boundaries can be parameterized and preferably saved and/or further processed using data technology. In other words, ordered data structures are generated that define a virtual linear driving surface boundary and correspond to a physical driving surface boundary in the vehicle environment as its representation.

The environment recognition system is preferably AI-based and comprises at least one trained AI module, more preferably a trained neural network. The environment recognition system can be a computer-implemented environment detection method. Alternatively or additionally, the environment recognition system may be a computer-implemented environment detection device.

### BRIEF DESCRIPTION OF THE DRAWINGS

The disclosure is illustrated by way of example in the figures. Shown are:

FIG. 1: a schematic representation of an ordered data structure,

FIG. 2: An example of a training procedure,

FIG. 3: An exemplary process of a recognition method for recognizing physical linear driving surface boundaries in momentary environment detection data of a vehicle by a trained neural network,

FIG. 4: An example of environment detection data in which several physical linear driving surface boundaries are present, with superimposed display of the associated virtual linear driving surface boundaries, and

FIG. 5: A set of environment detection data in which several physical linear driving surface boundaries are present, with a superimposed representation of weighting values that can be used within a training procedure as the measure of consideration of a support point in the optimization of an error function.

### DETAILED DESCRIPTION

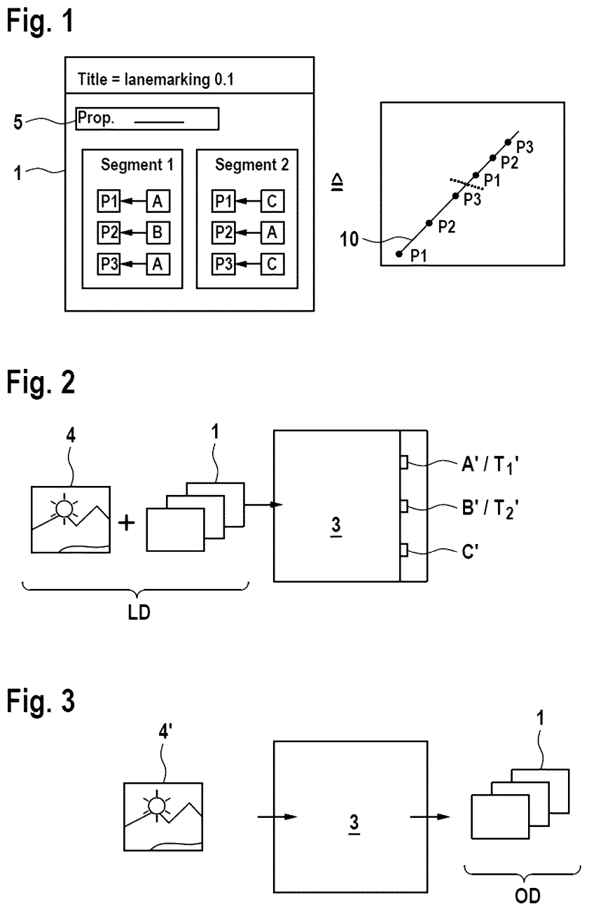

FIG. 1 shows a schematic representation of an ordered data structure according to the present disclosure. The data structure is provided for the computer-readable representation of a physical linear driving surface boundary Lim in the surroundings of a vehicle, whereby this representation is available as a virtual linear driving surface boundary 10. The ordered data structure 1 is stored in a memory or communicated via a data interface. It can be a component of a training data set LD for training an environment recognition system 3. Alternatively or additionally, it can be component of an output data set OD of an environment recognition system.

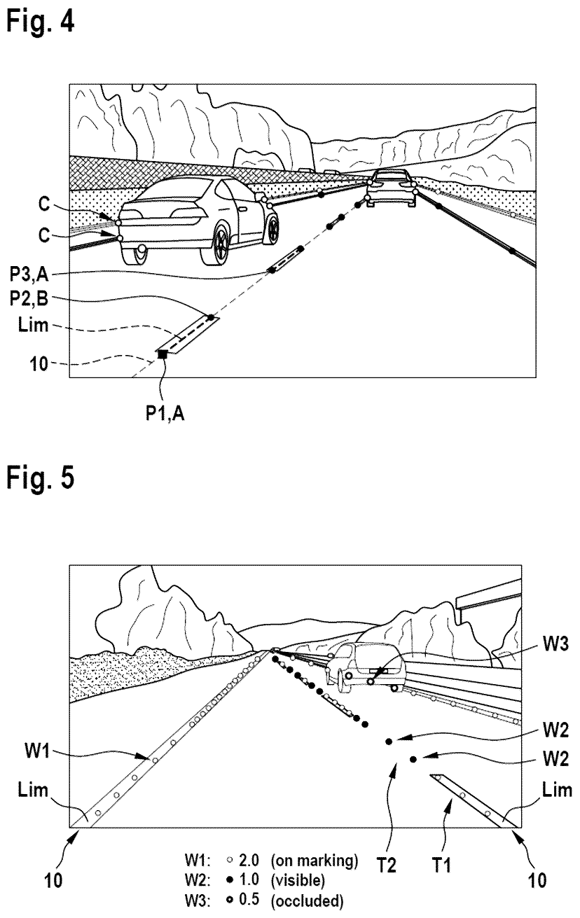

FIG. 2 illustrates an example of a training data set LD. This comprises environment detection data 4, which is a sensory representation of a vehicle environment in which the at least one physical linear driving surface boundary LIM is located. The training data set preferably comprises a plurality of environment detection data (e.g. camera images) in which sensory representations of physical driving surface boundaries are present. In addition, the training data set can comprise further environment detection data (e.g. further camera images) in which there are no sensory representations of physical driving surface boundaries. This additional environment detection data can be used for generalization and avoidance of false-positive detections during training. The illustrations in FIGS. 4 and 5 can be examples of such a sensory representation of the vehicle environment. In addition, the training data set comprises one or preferably more ordered data structures according to the present disclosure. It is particularly preferable for at least one corresponding ordered data structure to be available for each physical linear driving surface boundary Lim in the sensory environment of the vehicle.

FIG. 3 illustrates the implementation of a recognition process based on AI-based environment detection system 3, in particular comprising a neural network, wherein the environment detection system 3 and/or the neural network is trained by a training procedure according to the present disclosure. The AI-based environment detection system 3 incorporates current environment detection data 4′, which is a sensory representation of the current vehicle environment in which at least one physical linear driving surface boundary LIM is located, and outputs, as component of the output data set OD, at least one ordered data structure that is a representation of the physical linear driving surface boundary LIM in the form of a virtual linear driving surface boundary 10.

The ordered data structure 1 according to FIG. 1 defines at least one line object with a list of support points P1, P2, P3. The support points P1, P2, P3 may optionally be grouped into line segments. A semantic line property 5 is assigned to the line object, which identifies the line object as a whole as a (specific) virtual linear driving surface boundary. For example, the property can define “left lane marking ego lane” or “right lane marking ego lane” or comparable properties.

A separate semantic point property A, B, C is assigned to at least one of the support points P1, P2, P3. According to a preferred embodiment, a separate semantic point property can be assigned to a plurality of support points and, in particular, to all support points.

The semantic point property A, B, C can be defined in any way. A first preferred embodiment, illustrated in FIG. 4, defines a transition to or from a line detection type T1, T2, in particular:
Start lane marker
End lane marker
End occlusion

Alternatively or additionally, a semantic point property can be provided that defines the existence of a local assignment to a line detection type T1, T2, in particular:
Part of a lane marker
Part of a gap between lane markers
Part of an internal occlusion
Part of an edge occlusion

As can be seen from the example in FIGS. 4 and 5, the virtual linear driving surface boundaries 10 may preferably be defined according to an end-to-end definition, wherein a first support point lies at a vanishing point, and a second support point lies on an edge portion of the environment detection data 4.

A training procedure for training AI-based environment detection for recognizing physical linear driving surface boundaries in the vehicle environment is particularly useful when the environment detection system comprises a neural network. The neural network may be configured as desired. Preferably, a point coordinate for a support point P1, P2, P3 is defined as a regression problem in the neural network. Alternatively or additionally, a semantic line property can be defined as a classification problem. In the training procedure, the training data set LD is read in, which comprises the environment detection data and also at least one ordered data structure as described above. During training, the error functions of the neural network are optimized using the training data set LD as a fundamental truth.
On the one hand, a semantic point property A′, B′, C′ to be determined can be defined in the neural network as a point classification problem, preferably in addition to the regression problem for a point coordinate of the support point. The semantic point property A, B, C (in the training data) assigned to a support point P1, P2, P3 can be processed for the optimization of the classification error function.

Alternatively or additionally, a semantic line detection type T1′, T2′ to be determined can be defined in the neural network as a line classification problem. The semantic point properties assigned to two support points P1, P3 in the training data set, which in particular define the start and/or end of a lane marker or the start and/or end of an occlusion or other correspondingly suitable transitions, can be processed for the optimization of the classification error function.

In other words, the recognition technique according to the present disclosure can train an AI-based environment detection system 3, in particular a neural network, to recognize the beginning and/or end of a lane marker as well as the beginning and/or end of an occlusion of a lane marking and to semantically distinguish it from other points. On the other hand, it can be taught to recognize points that are part of a lane marker, or part of a gap between lane markers, or part of an inland occlusion, or part of an edge occlusion, and to distinguish such points from other points.

According to a preferred embodiment, the technical implementation can provide for an output layer with a channel in the neural network, which represents a regression value of a support point. These can be assigned an additional channel for the point classification problem as one-hot coding. A cross-correlation can preferably be used for the associated classification error function. Furthermore, a semantic point property that is assigned to a support point in the training data set is preferably transformed into a one-hot encoding during training.

Another independent but combinable implementation is that the neural network comprises an output layer with a channel that represents a regression value of a line object. An additional channel for the line classification problem can be assigned to these as a detection type encoding. A first implementation provides that two semantic point properties A, which in particular define a transition, and which are assigned to a pair of suitable follow-up support points P1, P3 in the training data set LD, are used by selecting a suitable line detection type T1, T2. The selected line detection type T1, T2 can be used to optimize the error function for the line classification problem.

An alternative or additional implementation provides that a semantic point property A, B, C, which in particular defines the existence of a local assignment, and which is assigned to a support point or several follow-up support points in the training data set LD, is used (directly) as a line detection type T1, T2 for the optimization. According to a preferred embodiment, different weighting levels W1, W2 can be defined for the training procedure, which specify the extent to which a support point P1, P2, P3 is taken into account in the optimization of an error function. In the example in FIG. 5, a first weighting level with the value 2.0 is provided for those points that are part of a lane marker according to an assigned semantic point property and/or are assigned to the start or end of a lane marker. A second weighting level with a value of 1.0 is intended for support points that are part of a gap between lane markers according to an assigned semantic point property. A third weighting level is set at a value of 0.5 and is intended for support points that, according to the assigned semantic point property, are part of an internal occlusion or part of an edge occlusion. The illustration in FIG. 5 and the above-mentioned stage classification are purely exemplary. Any other number of levels and any other assignment of weighting values can be provided.

A weighting level can be used to specify the extent to which a support point P1, P2, P3 is taken into account in the optimization of an error function. Within the training, one of the weighting levels can be selected for a support point in the LD training data set based on the assigned semantic point property. The error function is then adjusted for this support point during training according to the selected weighting level. In the example shown in FIG. 5, the support points that are marked as part of a lane marker are given a high weighting, while other support points that are part of an occlusion or a gap between lane markers are given significantly less consideration. In this way, the recognition of driving surface boundaries can achieve significantly higher sensitivity for data segments that are clearly recognizable as a component of lane markings in the environment detection data, while concealed areas or regions with gaps have less influence on recognition. Particularly in the case of an end-to-end definition of line objects, a significantly higher level of robustness can be achieved in processing. A higher weighting level therefore requires a comparatively stronger adjustment of the error function, while a lower weighting level requires a comparatively lower adjustment of the error function.

What is claimed is:

1. An ordered data structure for the computer-readable representation of a physical linear driving surface boundary in the environment of a vehicle as a virtual linear driving surface boundary, wherein the ordered data structure is stored in a memory or communicated via a data interface and is:
a. a component of a training data set for training an environment recognition system, wherein the training data set further comprises environment detection data which is a sensory representation of a vehicle environment in which the at least one physical linear driving surface boundary is located; or
b. a component of an output data set of an environment recognition; and wherein the ordered data structure defines at least one line object with a list of support points, wherein the line object is assigned a semantic line property which characterizes the line object as a whole as a virtual linear driving surface boundary,
wherein at least one of the support points is assigned a separate semantic point property.

2. The ordered data structure according to claim 1, wherein a plurality of support points are each assigned a separate semantic point property.

3. The ordered data structure according to claim 1, wherein the semantic point property defines a transition to or from a line detection type including at least one of the following:
a. start lane marker,
b. end lane marker,
c. start occlusion, and
d. end occlusion.

4. The ordered data structure according to claim 1, wherein the semantic point property defines the existence of a local assignment to a line detection type including at least one of the following:
a. part of a lane marker,
b. part of a gap between lane markers,
c. part of an internal occlusion, and
d. part of an edge occlusion.

5. An ordered data structure according to claim 1, wherein the virtual linear driving surface boundary has an end-to-end definition, and wherein a first support point lies in a vanishing point and a second support point lies on an edge portion of the environment detection data.

6. A training procedure for training an AI-based environment detection system for recognizing physical linear driving surface boundaries in the vehicle environment, wherein the environment detection system comprises a neural network in which a point coordinate for a support point is defined as a regression problem and/or a semantic line property is defined as a classification problem, wherein the training procedure contains instructions which, when executed on a data processing device, implement the following:
a. reading in a training data set comprising environment detection data which is a sensory representation of a vehicle environment in which the at least one physical linear driving surface boundary is located, and further comprising at least one ordered data structure according to claim 1;
b. optimizing error functions of the neural network using the training data set as a fundamental truth, wherein:
i. in the neural network, a semantic point property determined by the neural network is still defined as a point classification problem, and wherein the semantic point property assigned to a support point is processed for the optimization of the classification error function; and/or wherein:
ii. in the neural network, a semantic line detection type defined as a line classification problem, and wherein the semantic point properties assigned to two support points in the training data set are processed for the optimization of the classification error function.

7. The training procedure according to claim 6, wherein an additional channel for the point classification problem is assigned as one-hot encoding to a channel in an output layer of the neural network that represents a regression value of a support point, and a cross-correlation is used for the associated classification error function, and wherein a semantic point property assigned to a support point in the training data set is transformed into one-hot encoding.

8. The training procedure according to claim 6, wherein an additional channel for the line
classification problem is assigned to a channel in an output layer of the neural network representing a regression value of a line object as a detection type encoding, wherein:
a. two semantic point properties, which are assigned in the training data set to a pair of suitable follow-up support points, are used to select a suitable line detection type, and/or
b. a semantic point property, which is assigned to a support point or several follow-up support points in the training data set, is used as a line detection type.

9. The training procedure according to claim 6, wherein different weighting levels are defined, which specify the degree to which a support point is taken into account in the optimization of an error function, and wherein, during training, one of the weighting levels is selected for a support point in the training data set on the basis of an assigned semantic point property, and wherein the error function is adjusted for this support point in accordance with the selected weighting level.

10. The training procedure according to claim 9, wherein a higher weighting level is selected, which causes a comparatively stronger adjustment of the error function, if the assigned semantic property has the value “part of a lane marker,” and a lower weighting level is selected, which causes a comparatively smaller adjustment of the error function, if the assigned property has the value “part of a gap between lane markers,” “part of an interior occlusion,” or “part of an edge occlusion.”

11. The ordered data structure according to claim 1, wherein all support points are each assigned a separate semantic point property.

12. A training procedure for training an AI-based environment detection system for recognizing physical linear driving surface boundaries in the vehicle environment, wherein the environment detection system comprises a neural network in which a point coordinate for a support point is defined as a regression problem and/or a semantic line property is defined as a classification problem, wherein the training procedure contains instructions which, when executed on a data processing device, implement the following:
a. reading in a training data set comprising environment detection data which is a sensory representation of a vehicle environment in which the at least one physical linear driving surface boundary is located, and further comprising at least one ordered data structure;
b. optimizing error functions of the neural network using the training data set as a fundamental truth, wherein:
i. in the neural network, a semantic point property determined by the neural network is still defined as a point classification problem, and wherein the semantic point property assigned to a support point is processed for the optimization of the classification error function; and/or wherein:
ii. in the neural network, a semantic line detection type defined as a line classification problem, and wherein the semantic point properties assigned to two support points in the training data set are processed according to claim 3 for the optimization of the classification error function.

13. The training procedure according to claim 12, wherein an additional channel for the point classification problem is assigned as one-hot encoding to a channel in an output layer of the neural network that represents a regression value of a support point, and a cross-correlation is used for the associated classification error function, and wherein a semantic point property assigned to a support point in the training data set is transformed into one-hot encoding.
